(19) United States
(12) Patent Application Publication
(10) Pub. No.: US 2008/0276109 A1
(43) Pub. Date: Nov. 6, 2008

(54) IMAGE DISPLAY DEVICE HAVING BACKLIGHT

(75) Inventor: Tomonori YOSHIDA, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/113,529

(22) Filed: May 1, 2008

(30) Foreign Application Priority Data
May 2, 2007 (JP) 2007-121371

(51) Int. Cl. G06F 1/00

(52) U.S. Cl. 713/323; 713/340

(57) ABSTRACT

An image display device 1 includes, in a cabinet 2, a liquid crystal display 3 for displaying a video signal, a backlight 6 for irradiating the liquid crystal display 3, a power supply unit 8 for supplying power to the backlight 6, a microcomputer 4 for controlling the power supply, and a temperature sensor 5 for measuring temperature in the cabinet 2 and connected to the microcomputer 4. The microcomputer 4 can be selectively shifted between a standby mode of supplying power only to the microcomputer 4 and the temperature sensor 5 and stopping power supply to other electronic parts and a pseudo standby mode of displaying no image on the liquid crystal display 3 while maintaining light-on of the backlight 6. The microcomputer 4 has a switching function of shifting to the pseudo standby mode when it is determined in the standby mode that temperature data from the temperature sensor 5 is equal to or less than a first threshold value at which dew condensation in the cabinet 2 or an operation failure in an internal electronic part occurs.

### BACKGROUND OF THE INVENTION

1. Field of the Invention

The present invention relates to an image display device having a backlight and, more particularly, to an image display device such as a television receiver expected to be used under environment such as outside where it is exposed to the elements.

2. Background of the Invention

FIG. 4 is a block diagram of a conventional image display device (1) having a backlight (6) (refer to Japanese Unexamined Patent Application Publication No. 2004-69907). The backlight (6) such as a fluorescent lamp or an LED is provided at the back of a liquid crystal display (3) so that an image displayed on the liquid crystal display (3) is seen easily. The backlight (6) has a characteristic that when ambient temperature becomes low, the illuminance decreases and becomes low. Therefore, a temperature sensor (5) is provided near the backlight (6) in a cabinet (2). When the ambient temperature becomes lower than a predetermined value, the level of voltage supplied from a power supply unit (8) to the backlight (6) is increased via a microcomputer (4). Even when the ambient temperature becomes low, the illuminance of the backlight (6) is maintained almost constant. A prior art taking such a countermeasure is disclosed.

The image display device (1) of this kind has a standby mode. When not watched, the image display device (1) is shifted to the standby mode by a remote controller (7) or a switch (not shown) in the device. In the standby mode, to suppress standby electricity as much as possible, for example, power is supplied only to the microcomputer (4). In the standby mode, power is not supplied to the liquid crystal display (3) and the backlight (6).

The applicant has proposed an image display device as a television receiver in which the cabinet (2) is hermetically closed and, moreover, which is used on the outside. In this case, there is the possibility that the outside air temperature decreases, dew is formed in the cabinet (2), and an adverse influence is exerted on electronic parts in the cabinet (2). In the conventional image display device (1) shown in FIG. 4, the temperature sensor (5) is not adapted to a low temperature at which dew condensation occurs.

In particular, in cold regions where the temperature is lower than the freezing point, depending on the temperature characteristics of electronic parts, power supply is not easily turned on, and an inconvenience such that the device is not reset from the standby mode may occur. As a countermeasure, there is a method of maintaining the power supply unit (8) and the backlight (6) in the on state without setting the device into the standby mode. However, the method has an inconvenience such that the standby electricity is very large. The electronic parts tend to follow so-called Arrhenius' law that the higher the temperature is, the shorter the life becomes. When the power supply and the backlight (6) are set always in the on state, the life of the electronic parts in the cabinet (2) becomes shorter.

### SUMMARY OF THE INVENTION

The present invention provides an image display device capable of preventing occurrence of unsuccessful starting and dew condensation in cold regions while minimizing power consumption.

An image display device includes, in a cabinet (2): a display for displaying a video signal; a backlight (6) for irradiating the display; a power supply unit (8) for supplying power to the backlight (6); a microcomputer (4) for controlling the power supply; and sensor means for measuring temperature in the cabinet (2) and connected to the microcomputer (4).

The microcomputer (4) can be selectively shifted between a standby mode of supplying power only to the microcomputer (4) and the sensor means and stopping power supply to other electronic parts and a pseudo standby mode of displaying no image by transmitting a dark signal to the display while maintaining light-on of the backlight (6).

The microcomputer (4) has a switching function of shifting to the pseudo standby mode when it is determined in the standby mode that temperature data from the sensor means is equal to or less than a temperature corresponding to a first threshold value.

The first threshold value is a temperature value at which dew condensation in the cabinet (2) or an operation failure in an internal electronic part occurs.

When the temperature in the cabinet (2) becomes a low temperature at which dew condensation or an operation failure in an internal electronic part occurs, the microcomputer (4) shifts to the pseudo standby mode and turns on the backlight (6). However, a dark signal is transmitted to the display so that no image is displayed, and no light is emitted forward from the display. By light-on of the backlight (6), the inside of the cabinet (2) is heated, so that dew condensation or an operation failure in an internal electronic part can be effectively prevented. Only when the temperature in the cabinet (2) becomes equal to or lower than the first threshold value, the backlight (6) is turned on. Consequently, as compared with the case where the power supply and the backlight (6) are always on, the life of the electronic parts is longer.

In the pseudo standby mode, although power is supplied to the backlight (6), no image is displayed on the display and light is not emitted from the display by the dark signal. Consequently, a viewer does not know the turn-on of the backlight (6) and does not feel odd.

### BRIEF DESCRIPTION OF THE DRAWINGS

FIG. 1 is an internal block diagram of an image display device of an embodiment of the present invention;

FIG. 2 is a flowchart showing operations of a microcomputer;

FIG. 3 is a diagram showing the relation between first and second threshold values of temperature;

FIG. 4 is a block diagram showing a conventional image display device; and

FIG. 5 is a diagram showing the relation between first and second threshold values of humidity.

### DESCRIPTION OF THE PREFERRED EMBODIMENT

An embodiment of the present invention will be described in detail hereinbelow with reference to the drawings.

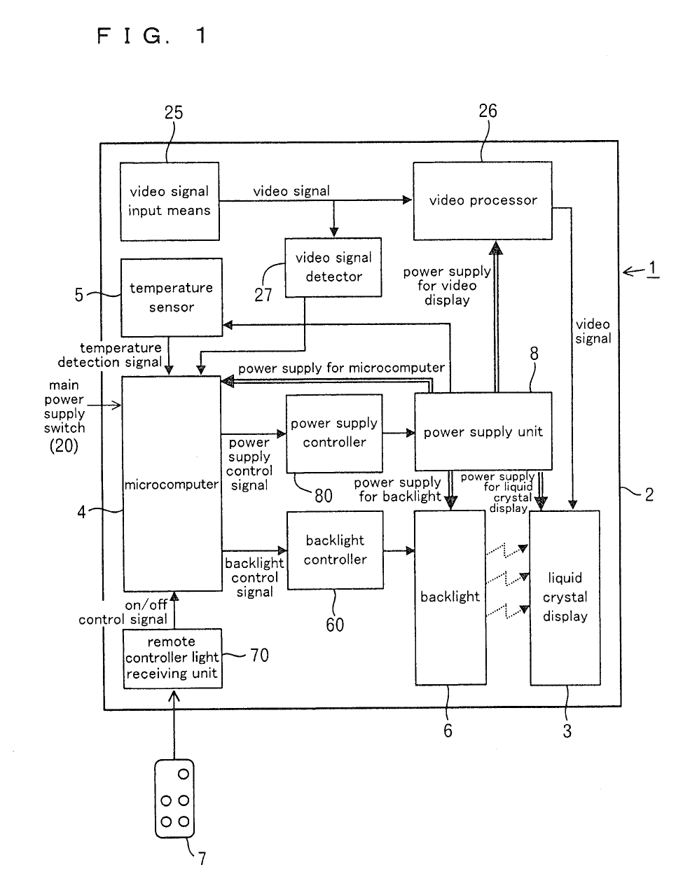

FIG. 1 is an internal block diagram of an image display device (1) of an embodiment of the present invention. It is assumed that the image display device (1) of the embodiment is a television receiver used outside, but the invention is not limited to the assumption.

In a cabinet (2), in a manner similar to the conventional technique, a liquid crystal display (3) and a backlight (6) are provided. Power is supplied from a power supply unit (8) to the liquid crystal display (3) and the backlight (6). The on/off state of the power supply unit (8) is determined by a user operating a main power supply switch (20) on the cabinet (2). Therefore, in the off state of the power supply unit (8), power is not supplied to electronic parts in the cabinet (2). The image display device (1) of the embodiment has a standby mode as in the conventional technique and also, as will be described later, a pseudo standby mode of displaying no image by sending a black signal as a dark signal to the liquid crystal display (3) while maintaining the light-on state of the backlight (6).

The backlight (6) and the power supply unit (8) are connected to a microcomputer (4) as control means via a backlight controller (60) and the power supply controller (80) respectively. To the microcomputer (4), a remote controller light receiving unit (70) for receiving an infrared signal of a remote controller (7) is connected. A signal from a temperature sensor (5) is inputted to the microcomputer (4). In a memory in the microcomputer (4), a first threshold value as a temperature level at which dew condensation in the cabinet (2) or an operation failure in an internal electronic part occurs is pre-stored.

A signal from video signal input means (25) as a video input terminal provided for the cabinet (2) is subject to a process such as correction in a video processor (26), and the processed signal is transmitted to the liquid crystal display (3). The signal from the video signal input means (25) is inputted to the microcomputer (4) via a video signal detector (27). When the video signal is not inputted from the video signal input means (25) after predetermined time, the microcomputer (4) shifts to the standby mode from a state where the power supply unit (8) supplies power to the liquid crystal display (3) and the backlight (6).

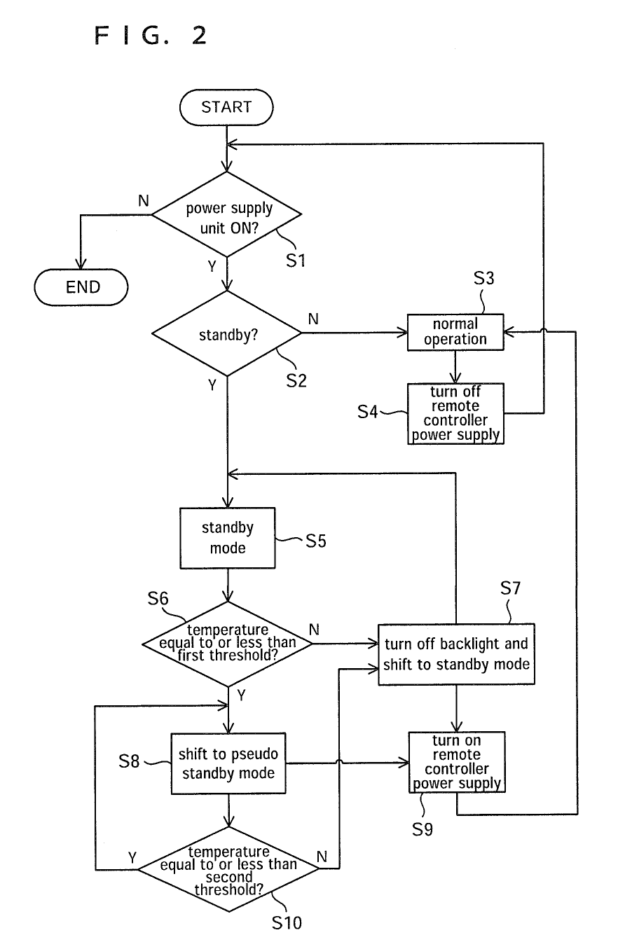

FIG. 2 is a flowchart showing operations of the microcomputer (4). When the user turns on the power supply unit (8) (S1) to supply power to the image display device (1), the microcomputer (4) confirms that it is not set in the standby mode (S2) and shifts to normal operation. That is, power is supplied to the video processor (26), the backlight (6), and the liquid crystal display (3) to display an image on the liquid crystal display (3) (S3). After that, in the case where the remote controller light receiving unit (70) receives a power-off signal, that is, the user turns off the remote controller (7) and does not watch an image (S4), if the power supply unit (8) is on, the microcomputer (4) shifts to the standby mode (S2 and S5). The microcomputer (4) turns off the backlight (6), and the power supply unit (8) supplies power only to the microcomputer (4) and the temperature sensor (5) and stops power supply to other electronic parts.

Since the cabinet (2) is made of a metal and has a heat absorption effect, when the temperature of outside air decreases, the temperature in the cabinet (2) sharply decreases. In the case where the temperature data from the temperature sensor (5) is lower than the first threshold value (S6), there is the possibility that dew condensation occurs in the cabinet (2) or an operation failure in an electronic part in the cabinet (2) occurs. In this case, the microcomputer (4) shifts to the pseudo standby mode (S8).

In the pseudo standby mode, power is supplied to the backlight (6) to light on and the temperature in the cabinet (2) is increased. All black signals as dark signals (black to all of liquid crystal pixels) are outputted from the video processor (26) and inputted to the liquid crystal display (3) so that the user does not see light-on of the backlight (6). In the pseudo standby mode, power is supplied to the backlight (6) but no image is displayed on the liquid crystal display (3) and light is not emitted forward from the liquid crystal display (3) by a black image. As a result, the light-on of the backlight (6) is not recognized by the viewer so that the viewer does not feel odd.

The microcomputer (4) continuously detects temperature data from the temperature sensor (5) not only in the case where a power-off signal is received from the remote controller light receiving unit (70) but also during setting of the standby mode.

In the microcomputer (4), not only the first threshold value but also a second threshold value as a temperature value slightly higher than the first threshold value are stored. By turning on the backlight (6), the temperature in the cabinet (2) rises. Consequently, after achieving the subject of preventing dew condensation or an operation failure in an electronic part in the cabinet (2), by turning off the backlight (6), power consumption can be reduced and the life of the backlight (6) can be prevented from being shortened. Therefore, when the temperature data from the temperature sensor (5) exceeds the second threshold value, the backlight (6) is turned off, and the microcomputer (4) shifts to the standby mode (S10 and S7). When the user turns on the remote controller (7) in the standby mode, the normal operation is performed and an image is displayed on the liquid crystal display (3) (S9 and S3).

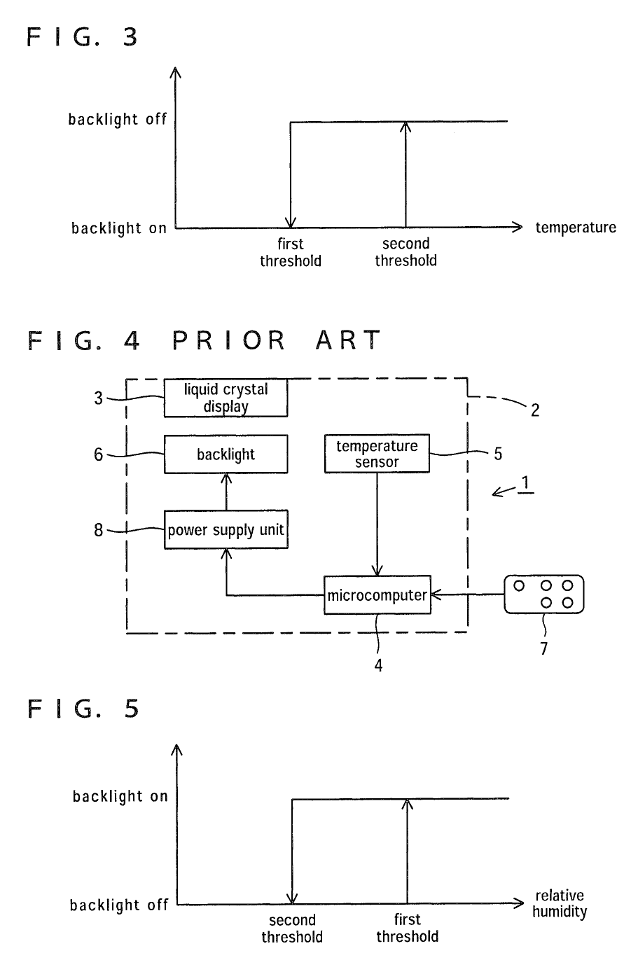

The reason why the second threshold value is slightly higher than the first threshold value will be described with reference to FIG. 3. When the temperature in the cabinet (2) becomes equal to or lower than the temperature corresponding to the first threshold value, the backlight (6) is turned on. Consequently, the backlight (6) may be turned off when the temperature in the cabinet (2) becomes equal to or higher than the first threshold value. However, when the temperature in the cabinet (2) becomes equal to or lower than the first threshold value, the backlight (6) is turned on. When the temperature even slightly exceeds the first threshold value, the backlight (6) is turned off. Therefore, a phenomenon similar to chattering that the backlight (6) is turned on/off repeatedly occurs around the first threshold value.

Consequently, by setting the second threshold value to a temperature value slightly higher than the first threshold value, an inconvenience that the backlight (6) is turned on/off repeatedly around the temperature value is prevented.

Other temperature control techniques can be also applied.

The video signal input means (25) is connected to, for example, a reception antenna. However, there is a case that a video signal is not inputted from the video signal input means (25) due to end of broadcasting or the like. When the video signal detector (27) detects that no video signal is inputted from the video signal input means (25), it notifies the microcomputer (4) of the fact. The microcomputer (4) automatically sets the standby mode and turns off the backlight (6). After that, when the temperature data from the temperature sensor (5) becomes lower than the first threshold value, the microcomputer (4) shifts to the pseudo standby mode.

In the embodiment, a shift from the standby mode to the pseudo standby mode is determined based on the data from the temperature sensor (5). In place of the temperature sensor (5) for sensing temperature data, a humidity sensor for detecting humidity data may be used.

When the temperature of outside air decreases, naturally, relative humidity rises. As it is known, the relative humidity is obtained by dividing the water vapor amount in the air by a saturated water vapor amount. When the relative humidity exceeds 100%, the amount exceeding the saturated water vapor amount brings dew condensation. Therefore, the relative humidity in the cabinet (2) may be detected by using the humidity sensor. In this case, when the relative humidity exceeds the first threshold value, dew condensation easily occurs. The second threshold value of the relative humidity is set lower than the first threshold value.

That is, as shown in FIG. 5, when the relative humidity exceeds the first threshold value, the microcomputer (4) shifts to the pseudo standby mode in which the backlight (6) is turned on to increase the temperature in the cabinet (2) and to lower the relative humidity. When the relative humidity becomes lower than the second threshold value, it is determined that the relative humidity becomes sufficiently low, and the standby mode is automatically set to turn off the backlight (6).

What is claimed is:

1. An image display device comprising, in a cabinet:
a display for displaying a video signal;
a backlight for irradiating the display;
a power supply unit for supplying power to the backlight;
a microcomputer for controlling the power supply; and
sensor means for measuring temperature in the cabinet and connected to the microcomputer,
wherein the microcomputer can be selectively shifted between a standby mode of supplying power only to the microcomputer and the sensor means and stopping power supply to other electronic parts and a pseudo standby mode of displaying no image by transmitting a dark signal to the display while maintaining light-on of the backlight, and
the microcomputer has a switching function of shifting to the pseudo standby mode when it is determined in the standby mode that temperature data from the sensor means is equal to or less than a temperature corresponding to a first threshold value.

2. The image display device according to claim 1, wherein the microcomputer has a switching function of shifting to the standby mode when it is determined in the pseudo standby mode that temperature data from the sensor means is equal to or higher than a temperature corresponding to a second threshold value, and
the second threshold value indicates a value of temperature higher than the first threshold value.

3. The image display device according to claim 1, wherein the first threshold value is a temperature value at which dew condensation in the cabinet or an operation failure in an internal electronic part occurs.

4. An image display device comprising, in a cabinet:
a display for displaying a video signal;
a backlight for irradiating the display;
a power supply unit for supplying power to the backlight a microcomputer for controlling the power supply; and
sensor means for measuring humidity in the cabinet and connected to the microcomputer,
wherein the microcomputer can be selectively shifted between a standby mode of supplying power only to the microcomputer and the sensor means and stopping power supply to other electronic parts and a pseudo standby mode of displaying no image by transmitting a dark signal to the display while maintaining light-on of the backlight, and
the microcomputer has a switching function of shifting to the pseudo standby mode when it is determined in the standby mode that humidity data from the sensor means is equal to or higher than a humidity corresponding to a first threshold value.

5. The image display device according to claim 4, wherein the microcomputer has a switching function of shifting to the standby mode when it is determined in the pseudo standby mode that humidity data from the sensor means is equal to or lower than a humidity corresponding to a second threshold value, and
the second threshold value indicates a value of humidity lower than the first threshold value.

6. The image display device according to claim 4, wherein the first threshold value is a humidity value at which dew condensation in the cabinet or an operation failure in an internal electronic part occurs.

7. The image display device according to claim 1, wherein the cabinet is hermetically closed and adapted to the outdoor use.

8. The image display device according to claim 4, wherein the cabinet is hermetically closed and adapted to the outdoor use.
